(19) United States
(12) Patent Application Publication
(10) Pub. No.: US 2025/0173705 A1
(43) Pub. Date: May 29, 2025

(54) SYSTEM AND METHODS FOR SECURELY PROVISIONING AND STORING A CRYPTOCURRENCY WALLET

(71) Applicant: Capital One Services, LLC, McLean, VA (US)

(72) Inventors: Kevin OSBORN, Newton Highlands, MA (US); Andrea MONTEALEGRE, Arlington, VA (US); Asher SMITH-ROSE, Midlothian, VA (US)

(21) Appl. No.: 18/521,990

(22) Filed: Nov. 28, 2023

(51) Int. Cl. G06Q 20/36; G06Q 20/38; G06Q 20/40

(52) U.S. Cl. CPC G06Q 20/3678; G06Q 20/3821; G06Q 20/3829; G06Q 20/4018; G06Q 2220/00

(57) ABSTRACT

The present embodiments include a system and method for provisioning, storing, and deriving a cryptocurrency wallet. The system includes a card, a user device, an administrator processor, and a server. The method includes generating a private key and a public key over a user datum, encrypting the keys over a key-encryption-key (KEK), and transmitting the keys to a card. The keys can be optionally stored on a server in encrypted form. Alternatively, the keys can be derived from the user datum if the user has lost them.

### FIELD OF DISCLOSURE

The present disclosure relates to systems and method for securely provisioning and storing a cryptocurrency wallet.

### BACKGROUND

Cryptocurrency wallets are the most common method of storage for cryptocurrencies. To access a wallet, one needs a private key. The private key is often a long list of characters that acts as a password for accessing the wallet. In current markets, there are only two main options for storing a private key: a hot (or online) wallet and a cold (or offline) wallet. The private key can be stored online or on a server—this is known as a hot wallet, called so because they are vulnerable to hacking. Hot wallets are not recommended for users with a significant amount of cryptocurrency. Alternatively, a private key can be stored offline or on hardware copy—this is called a cold wallet.

Though these methods avoid the risk of hacking, it is extremely prone to being lost and/or forgotten. For example, a hardware wallet can be misplaced, stolen, or damaged. Consequently, the holder of a damaged wallet loses access to his wallet and the all the value associated with it. So, wallet holders are given two difficult choices: use a cold wallet with the risk of hacking; or use a hot wallet with the risk of loss or damage.

These and other deficiencies exist. Therefore, there is a need to provide a system for securely provisioning and storing cryptocurrency wallets.

### SUMMARY OF THE DISCLOSURE

Embodiments of the present disclosure provide a system for the provisioning of a cryptocurrency wallet. The system includes a card, an administrator processor, and a server. The administrator processor is configured to receive a request to generate a private key, a public key, and a key-encrypted-key (KEK). Then, the administrator processor can receive a user datum from the card and transmit the user datum to a server. Next, the administrator processor can receive, from the server, at least an encrypted private key, an encrypted public key, and an encrypted KEK from the server, then transmit, to the card, the encrypted private key, encrypted public key, and KEK. The server comprises a memory containing a database, and a server processor. The server processor can receive, over a network, the user datum from the administrator processor then generates the private key and public key over the user datum. The server processor can also generate the KEK. Next, the server processor can store the private key, public key, and KEK in the database. Next, the server processor can encrypt the private key and public key over the KEK, and transmit, over the network, the encrypted private key, encrypted public key, and KEK to the administrator processor.

Embodiments of the present disclosure provide a method for the provisioning of a cryptocurrency wallet. The method can begin with receiving, by an administrator processor, a request to generate a private key, a public key, and a key-encrypted-key (KEK). Next, the method proceeds with receiving, by the administrator processor over a network, a user datum from a card then transmitting, by the administrator processor over the network, the user datum to a server. Nex, the method proceeds with receiving, by the administrator processor from the server, an encrypted private key, an encrypted public key, and a KEK from the server, wherein the server has generated the private key and public key over the user datum and has encrypted the private and public keys over the KEK. Then, the method proceeds with transmitting, by the administrator processor to the card, the encrypted private key, the encrypted public, and the KEK.

Embodiments of the present disclosure also provide a non-transitory computer-readable storage medium, the computer-readable storage medium including instructions that, when executed by a computer hardware arrangement comprising a processor, configure the processor to perform procedures that include with following: The procedures can include receiving a request to generate a private key, a public key, and a key-encrypted-key (KEK) and receiving, over a network, a user datum from a card. Next, the procedures include transmitting, over the network, the user datum to a server and receiving, from the server, an encrypted private key, an encrypted public key, and an encrypted KEK from the server, wherein the server has generated the private key and public key over the user datum and has encrypted the private and public keys over the KEK. The procedures can include transmitting, to the card, the encrypted private key, the encrypted public, and the KEK.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a block diagram illustrating a system according to an exemplary embodiment.

FIG. 2 is a diagram illustrating a card according to an exemplary embodiment.

FIG. 3 is a diagram illustrating a card according to an exemplary embodiment.

FIG. 4A-4B are flowcharts illustrating a process according to an exemplary embodiment.

FIG. 5 is a flowchart illustrating a process according to an exemplary embodiment.

FIG. 6 is a sequence diagram illustrating a method according to an exemplary embodiment.

FIG. 7 is a sequence diagram illustrating a method according to an exemplary embodiment.

FIG. 8 is a sequence diagram illustrating a method according to an exemplary embodiment.

FIG. 9 is a sequence diagram illustrating a method according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Generally, the present disclosure relates to systems and methods for securely provisioning a cryptocurrency wallet to a user. Example embodiments of the systems and methods provide a quick and secure process for obtaining a cryptocurrency wallet and storing the wallet so that the user can retrieve the wallet if the private or public key is lost.

In some examples, the user has a contactless card with some user information or user datum. To obtain the private key and public key necessary to open a wallet, the user can interact with an administrator processor. An administrator processor can include without limitation an automated teller machine (ATM). The user can ask the ATM to generate a private key and public key. The ATM, upon receiving the request, can ask for user information. In response, the user can tap the card to the ATM via a communication field. The card can send user datum such as a unique customer identifier. The ATM sends the user datum to a server. The server generates a private key and a public key over the user datum. The server can store the keys in a database for later retrieval if, for example, the user loses their keys. Then, the server encrypts the private key and the public key over a key-encryption key and transmits all three keys to the ATM. The ATM then transmits the keys to the card.

Systems and methods described herein provide a quick and efficient way to create a cryptocurrency wallet. Rather than create a wallet online at the risk of sharing sensitive information, the user can create a wallet within the safer, quicker area of the ATM. The communication field between the ATM and card significantly reduces the chances of inadvertently sharing personal information.

Furthermore, the systems and methods described herein incur much less risk of losing the private and public keys to a malicious party because card itself has the keys only in encrypted form. By provisioning only the server with the unencrypted keys, the user can rest assured that their wallet is safe from theft or damage. If the user loses their card, the user can initiate some other identity verification with the owner of the server.

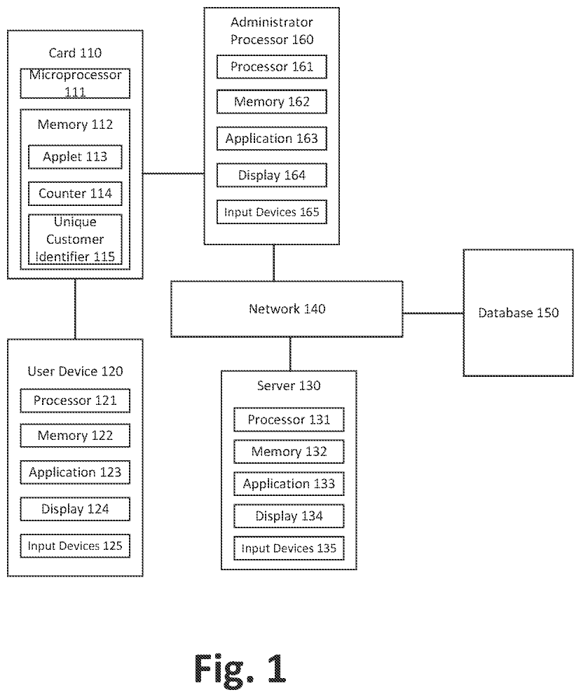

FIG. 1 is a block diagram of a system according to an exemplary embodiment.

FIG. 1 illustrates a system 100 according to an example embodiment. The system 100 may comprise a contactless card 110, a user device 120, a server 130, a network 140, a database 150, and an administrator processor 160. Although FIG. 1 illustrates single instances of components of system 100, system 100 may include any number of components.

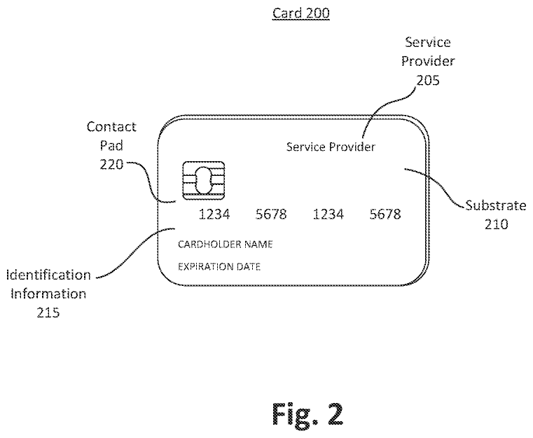

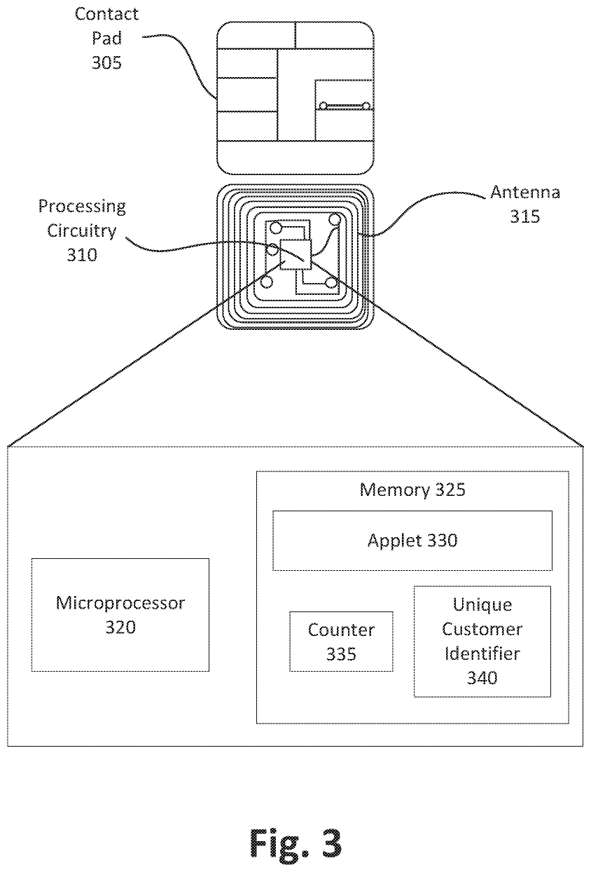

System 100 may include one or more contactless cards 110 which are further explained below with reference to FIG. 2 and FIG. 3. In some embodiments, contactless card 110 may be in wireless communication, utilizing NFC in an example, with user device 120.

System 100 may include a user device 120. The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the user device 120. In some examples, the user device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that can be available and supported by the server 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user device 120, the server 130, the database 150 and the administrator processor 160. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 130, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

The administrator processor may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The administrator processor 160 may include a processor 161, a memory 162, and an application 163. The processor 161 may be a processor, a microprocessor, or other processor, and the administrator processor 160 may include one or more of these processors. The administrator processor can be onsite, offsite, standalone, networked, online, or offline.

The processor 161 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 161 may be coupled to the memory 162. The memory 162 may be a read-only memory, write-once read-multiple memory or read/write memory, e.g., RAM, ROM, and EEPROM, and the administrator processor 160 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 162 may be configured to store one or more software applications, such as the application 163, and other data, such as user's private data and financial account information.

The application 163 may comprise one or more software applications comprising instructions for execution on the administrator processor 160. In some examples, the administrator processor 160 may execute one or more applications, such as software applications, that enable, for example, network communications with one or more components of the system 100, transmit and/or receive data, and perform the functions described herein. Upon execution by the processor 161, the application 163 may provide the functions described in this specification, specifically to execute and perform the steps and functions in the process flows described below. Such processes may be implemented in software, such as software modules, for execution by computers or other machines. The application 163 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The administrator processor 160 may further include a display 164 and input devices 165. The display 164 may be any type of device for presenting visual information such as a computer monitor, a flat panel display, and a mobile device screen, including liquid crystal displays, light-emitting diode displays, plasma panels, and cathode ray tube displays. The input devices 165 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein. FIG. 2 illustrates a contactless card 200 according to an example embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, smart watch, some other wearable device, or tablet computer. The contactless card 200 may also include processing circuitry, antenna and other components not shown in FIG. 2. These components may be located behind the contact pad 220 or elsewhere on the substrate 210. The contactless card 200 may also include a magnetic strip or tape, which may be located on the back of the card (not shown in FIG. 2).

FIG. 3 illustrates a contactless card 200 according to an example embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

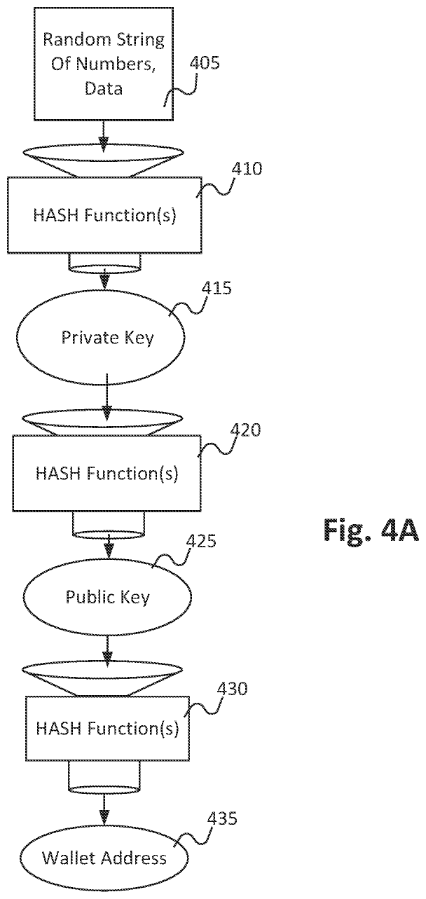

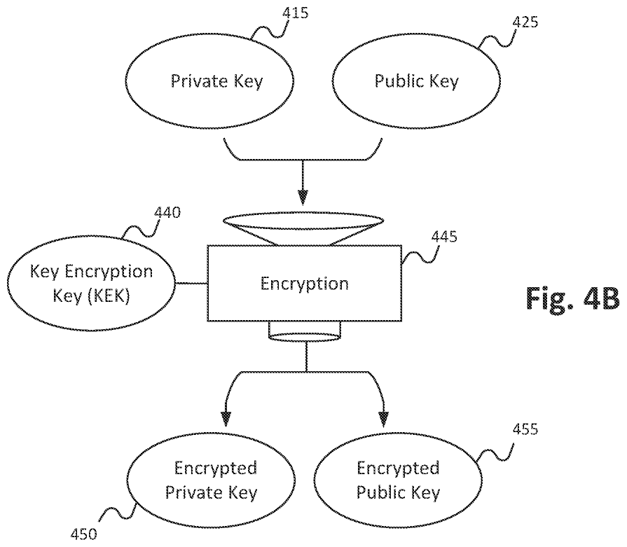

FIG. 4A is a diagram illustrating a process of creating private keys and public keys for a cryptocurrency wallet. The process is an example of how one or more private keys and public keys can be created.

In action 405, the user can create a random string of numbers, letters, characters, or other data. This data can be chosen by the user, or the user can operate a random number generator. The string of data can vary in length. This action can be done by a processor. The user can provide a unique user datum as their input data that will ultimately become the random string. As a nonlimiting example, the user can provide a unique customer ID from their contactless card or some other unique identifier associated with their card. As another nonlimiting example, the user can provide other customer information such as an account number, a counter value, or some combination of information associated with a financial account.

Next, in action 410 the random data can be operated upon by a hash function. A hash function can be any mathematical function that can be used to map a set of data into a different set of data. In some examples, a hash function can be a function that scrambles a piece of information so that the original information can be mathematically infeasible to figure out. The output of a hash function can be called a hash value, hash code, or simply a hash. Though there are many different kinds of hash functions, most hash functions convert variable-length keys into fixed-length values. For example, SHA256, a very common hash function, will always produce an output of 256 bits no matter the length of the input. Other hash functions will produce outputs of other lengths, including 32 bits, 64 bits, or 128 bits.

Most hash functions will create a unique value for every input. For example, inputting the random data set of “8;nm, desfnyt55 [9 [bdc, aq123” through the SHA256 hash function will always produce the same output of:

01d81ela585c9ac701e5e4cc24ddef098286ccef55167001f2ea5e41e06eaael

If the input is changed even slightly, the output will appear completely different. For example, if the last character of the input is changed from a 3 to a 4, the resulting output becomes:

1a48beda31b3f56b92eaa30050c0bd16c061ca366be0703d76dca46245a2dda9

Hash functions provide an added level of security to encryption and security access.

In action 415, the has function produces an output that becomes the private key. The private key can be a data set of indefinite length and of varying character use. For example, the private key may be a 256-bit string of characters ranging from 0-9 and the letters A through F. The private key can be used to access the crypto wallet.

In action 420, one or more hash functions are applied to the private key. The resulting output can be the public key 425. These hash functions used in action 420 may be the same hash functions used in action 410, or they may be different.

In some instances, the hash function in action 420 can be replaced with elliptic curve multiplication. It is not necessary to apply elliptic curve multiplication to a private key in order to make a public key. However, it offers an alternative method of scrambling the private key to make a public key. Elliptic curve multiplication is the action of multiplying the private key k by some constant G. One can call this operation (G) (k). The constant G is a pair of vertices on a two-dimensional elliptic curve. Calculating (G) (k) will produce a new value K. The new value K is another set of vertices on the same elliptic curve. Because the multiplication of vertices on an elliptic curve is unpredictable, the private key k cannot be derived easily from K. This new value resulting from (G) (k) is the public key in action 425.

In some examples, the private key and public key are all that is required to create a cryptocurrency wallet. However, in other examples, additional processing can be performed. In action 430, the public key is fed through a hash function. This hash function may or may not be the same hash function used in action 410 and in action 420.

In action 435, the hash function of action 430 produces a different set of data that is commonly referred to as the wallet address. The public key and the wallet address serve the same function of associating a cryptocurrency user with their cryptocurrency.

If a user loses their wallet, i.e. their private or public key, then it is possible to derive or recreate the private and public keys from the same string of random number or user datum. Assuming that the same hash functions are used, then the user can simply hash the same user datum to derive their crypto wallet. This procedure allows the user to easily recreate their crypto wallet in the event that their keys are lost.

Having generated the private key 415 and the public key 425 discussed with further reference to FIG. 4A, a processor can perform an encryption 445 of the two keys over a key-encryption-key (KEK) 440. The processor can be a microprocessor or some other processor, and the processor can be associated with the user device, the user device, or the server. The KEK can be a variable value that is applied to one or more keys with the specific purpose of encrypting the keys. The KEK can be generated using a hash or some other predetermined algorithm. Furthermore, the KEK can be generated over user information or randomly generated information. For example, the processor can generate the KEK over a second but different user datum. As another nonlimiting example, the KEK can be generated over a counter value associated with the card. As another nonlimiting example, the KEK can be generated over some unique transaction value created by the administrator processor or ATM. The processor, having encrypted the keys over the KEK, can generate the encrypted private key 450 and the encrypted public key 455. The processor can encrypt the private and public key one or more times over one or more KEKs or predetermined algorithms. Furthermore, it is understood that the server can generate multiple private keys, public keys, and KEKs.

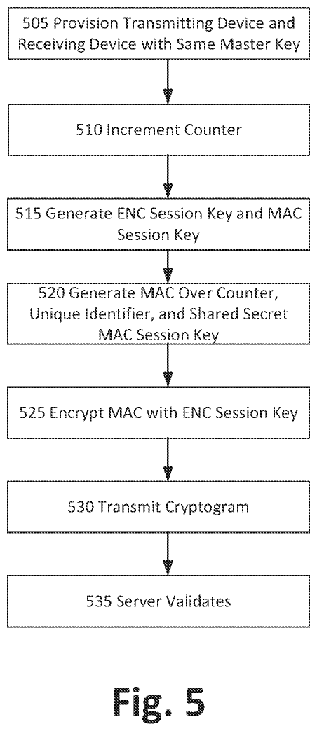

FIG. 5 is a flow chart of method 500 of key diversification according to an exemplary embodiment.

In some examples, a sender and recipient may desire to exchange data via a transmitting device and a receiving device. In some embodiments, the transmitting device is the contactless card and the receiving device is the server. As explained above, it is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device.

The transmitting device and the receiving device may be configured to communicate via NFC, Bluetooth, RFID, Wi-Fi, and/or the like. The transmitting device and the receiving device may be network-enabled computer devices. In some examples, the transmitting device may comprise a contactless card and the receiving device may comprise a server. In other examples, the receiving device may comprise a user device or a user device application.

The method 500 can begin with step 505. In step 510, a transmitting device and receiving device may be provisioned with the same master key, such as the same master symmetric key. The transmitting device may be the user device. The receiving device may be the contactless card. When the transmitting device is preparing to process the sensitive data with symmetric cryptographic operation, the transmitting device may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In step 510, the transmitting device may take the selected cryptographic algorithm, and using the master symmetric key, process the counter value 335. For example, the transmitting device may select a symmetric encryption algorithm, and use a counter which updates with every conversation between the transmitting device and the receiving device The one or more counters 335 may comprise a numeric counter sufficient to store an integer. The transmitting device may increment the counter one or more times. In step 515, the transmitting device generates two session keys: one ENC (encryption) session key and one MAC (message authentication code) session key. The transmitting device may encrypt the counter value with the selected symmetric encryption algorithm using the master symmetric key to create a session key.

In step 520, the transmitting device generates the MAC over the counter 335, the unique customer identifier 340, and the shared secret MAC session key. The customer identifier 340 may comprise a unique alphanumeric identifier assigned to a user of the contactless card, and the identifier may distinguish the user of the contactless card from other contactless card users. In some examples, the customer identifier 340 may identify both a customer and an account assigned to that customer and may further identify the contactless card associated with the customer's account.

In step 525, the transmitting device encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In step 530, the transmitting device transmits a cryptogram to the receiving device. The cryptogram can include the applet information 330, the unique customer identifier 340, the counter value 335, and the encrypted MAC.

In step 535, the receiving device validates the cryptogram.

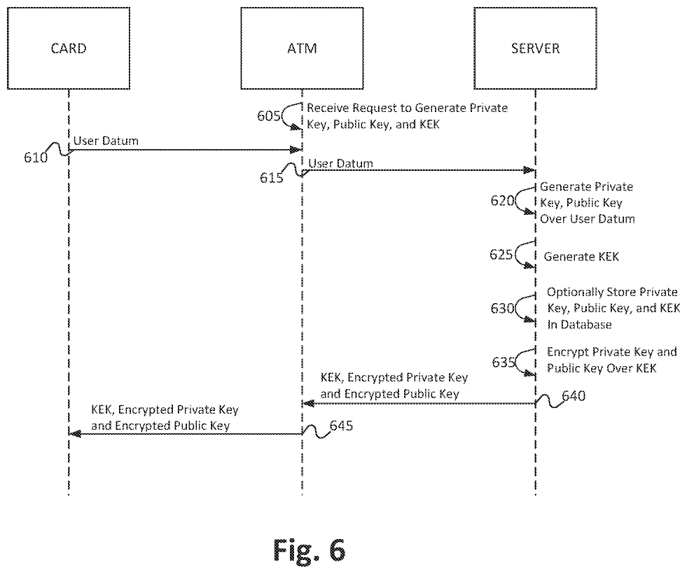

FIG. 6 is a sequence diagram. The sequence can include a contactless card, an ATM, and a server. It is understood that the ATM is just one example of an administrator processor and that other exemplary devices are included within the scope of this disclosure. The server can be associated with a banking institution, a cryptocurrency-related merchant, or some other financial institution.

In action 605, the ATM can receive a request to generate a cryptocurrency wallet including a private key, a public key, and a KEK. The generation of a private and public key are discussed with further reference to FIG. 4A. The ATM can receive the request from over a wired or wireless network. For example, the ATM can receive the request from a user interacting with a display or input device. In action 610, the user can transmit one or more user datum to the ATM. The user datum can include without limitation a unique customer identifier, a counter value, primary account number (PAN), a card verification value (CVV), or some other personal information. The user datum can be transmitted via a card reader associated with the ATM or via a communication field. The communication field can include without limitation Bluetooth, near field communication (NFC), or radio frequency identification (RFID). For example, the ATM may open the communication field in response to receiving the request to generating the wallet.

In action 615, the ATM can transmit the user datum to the sever. The user datum can be transmitted over a wired or wireless network. The server can be associated with a banking or financial institution. The ATM and the server can be associated with the same institution such that the ATM has a unique secure access to the server. The server can include a cloud server such as a private cloud, public cloud, hybrid cloud or multicloud.

Having received the user datum, the server in action 620 can generate a private key and a public key over the user datum. This action can be performed by a processor or predetermined algorithm associated with the server. The predetermined algorithm can be a hash discussed further with reference to FIG. 4A. As a nonlimiting example, the processor can generate the private key by hashing the user datum, then generate the public key by hashing the private key. Furthermore, a wallet address can be generated from either or both the private key and public key.

Next, in action 625 the processor can generate the KEK. The generation of the KEK is discussed with further reference to FIG. 4B.

In action 630, the server can optionally store the private key, public key, and KEK in a database or data storage unit. By storing the keys, the server can retrieve them if the user loses their key card.

In action 635, the server can encrypt the private key and public key over the KEK. This encryption is discussed further with reference to FIG. 4B. Having encrypted the private and public keys, the server can transmit the encrypted private key, encrypted public key, and KEK to the ATM. The processor associated with the server can transmit the keys over a wired or wireless network.

In action 645, the ATM transmits the encrypted private key, the encrypted public key, and the KEK to the user device. The ATM can transfer the keys in a number of ways. As a nonlimiting example, the ATM can open in response to receiving the encrypting keys a communication field between itself and the user device. The communication field can include Bluetooth, a near field communication field (NFC), or a radio frequency identification (RFID) field. Once the communication field opens, the user may place the card or some other user device within the field and exchange an authentication credential at which point the ATM can transmit the keys to the card. As another nonlimiting example, the card can interact with a card reader associated with the ATM.

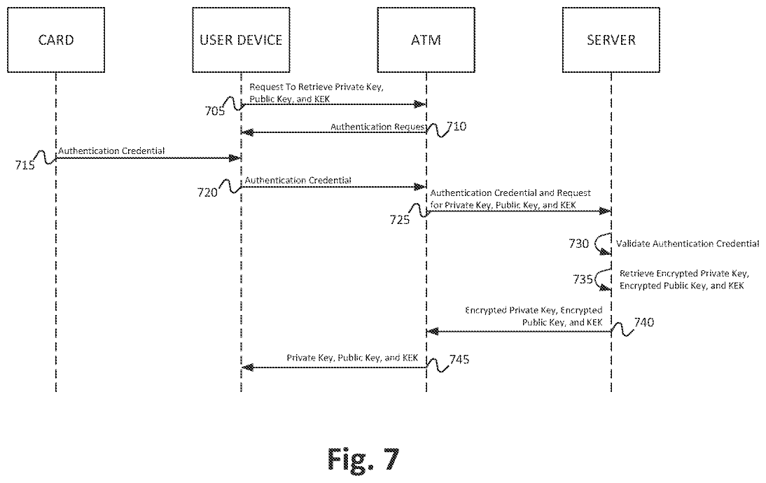

FIG. 7 is a sequence diagram illustrating a process according to an exemplary embodiment. The sequence can include a contactless card, a user device, an administrator processor, and a server. The administrator processor can be an ATM, for example. The server can be associated with a financial or banking institution. The card and the user device can be associated with the same users. The card can be associated with an account associated with a financial or banking institution which can be associated with the same institution that operates the ATM or server. Although FIG. 7 describes a user device, it is understood that a user device application may be used.

A user may lose their private or public keys that were previously provisioned by the server. To retrieve the keys, the user can simply approach an ATM associated with the server and request key retrieval.

In action 705, the user device can transmit to the ATM a request to retrieve the private key, public key, and KEK that was previously provisioned to their card. This provision process is discussed with further reference to FIG. 6. The user device can transmit this request over a wired or wireless network to that ATM. As another nonlimiting example, the user himself can interact with the ATM to generate the request. The user can perform this by interacting with the ATM's display or some other interactive element.

In response to receiving the key retrieval request, in action 710 the ATM can transmit an authentication request to the user device. This action can be performed by a processor associated with the ATM. The authentication request can be transmitted over a wired or wireless network to the user device. As another nonlimiting example, the ATM can display a prompt to the user requesting the authentication credential. The authentication credential can be exchanged using a diversified key exchanged discussed with further reference to FIG. 5.

In response to the authentication request, in actions 715 and 720 the user can transmit a user credential to the ATM. In one embodiment, the authentication credential in action 715 can be provided by a contactless card. The authentication credential can include without limitation a unique customer identifier, a digital signature, a counter value, or some other unique card datum. The credential can be transmitted from the card to the user device via a communication field such as a Bluetooth, NFC, or RFID. The authentication credential can be exchanged using a diversified key exchanged discussed with further reference to FIG. 5. Upon receiving the credential from the card, the user device in action 720 can transmit the credential to the ATM. The user device can transmit the credential over a wired or wireless network. As a nonlimiting example, the user device can interact with a communication field created by the ATM. Upon entering the communication field, the user device can transmit the credential via the communication field.

Although FIG. 5 describes the authentication credential being provided by the contactless card, it is understood that the authentication credential can be provided in other ways. For example, the authentication credential can include a biometric provided by the user including without limitation a fingerprint, facial scan, or voice scan. The user can provide the biometric to the user device which can in turn transmit it to the ATM. Alternatively, the user can provide the biometric to the ATM directly through an interactive element associated with the ATM such as a fingerprint scanner, a face scanner, or a voice scanner. As another nonlimiting example, the authentication credential can be associated with an account number, routing number, customer identification number, password, PIN number, or some other datum associated with a specific financial or banking account. It is understood that multiple authentication credentials can be requested and subsequently provided. The authentication credential can be exchanged using a diversified key exchanged discussed with further reference to FIG. 5.

Upon receiving the authentication credential, the ATM in action 725 can transmit to the server the authentication credential and a request to provide the private key, public key, and KEK previously provisioned to the user. This action can be performed by a processor associated with the ATM. The credential and the request can be transmitted over a wired or wireless network to the server.

In action 730, the server can validate the authentication credential. The credential can be validated by a processor, or some predetermined algorithm associated with the server. As a nonlimiting example, the processor can match the credential with a credential on file.

Having validated the credential, the server in action 735 can retrieve the encrypted private key, encrypted public key, and KEK that were previously provisioned to the user. The processor can retrieve the keys from a data storage unit or database. The processor can retrieve one or more sets of keys.

Next, in action 740 the server can transmit the encrypted private key, encrypted public key, and KEK to the ATM. The keys can be transmitted over a wired or wireless network.

Having received the keys, the ATM in action 745 can transmit the encrypted private key, encrypted public key, and KEK to the user device. The keys can be transmitted over a communication field. In other embodiments, the ATM can transmit the keys to the card over a communication field or card reader. As another nonlimiting example, the ATM can transmit the keys to the user device, which can in turn transmit the keys to the card.

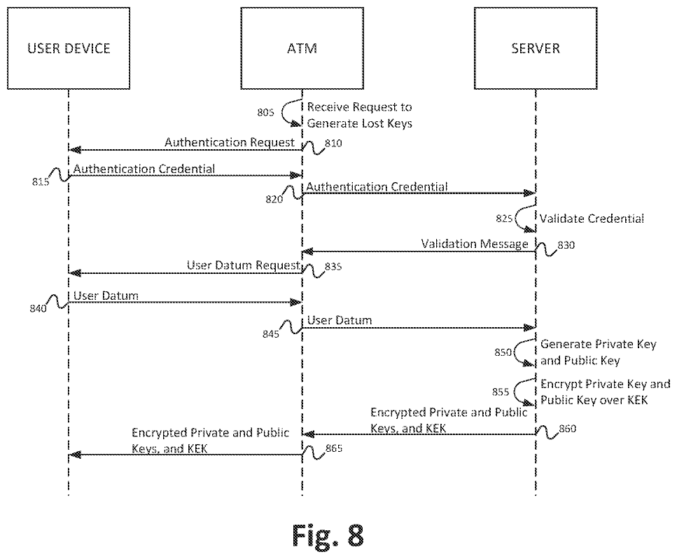

FIG. 8 illustrates a sequence diagram according to an exemplary embodiment.

To increase security, the key retrieval process can be performed by deriving the private and public keys from the same user datum used to provision the keys. This is an alternative to storing the keys on a databased associated with the server. The process can include a user device, an administrator processor, and a server. The administrator processor can be without limitation an ATM. Although FIG. 8 describes a user device, it is understood that a user device application may be used.

In action 805, the ATM can receive a request to derive or re-generate the lost keys. The request can be received from the user device or received from the user himself through an interactive element associated with the ATM. Upon receiving the request to derive the lost keys, the ATM can transmit an authentication request over a wired or wireless network to the user device. As another nonlimiting example, the ATM can display a prompt to the user requesting an authentication credential. In action 810 user device can receive an authentication request. The authentication request can be received over a wireless network. In some embodiments, the authentication request can be received from the ATM. In other embodiments, the authentication request can be received from the server.

In action 815, the user can provide the authentication credential. As a nonlimiting example, the authentication credential can be provided via the user device. The credential can be transmitted from the user device to the ATM via a communication field such as a Bluetooth, NFC, or RFID. The authentication credential can include without limitation a unique customer identifier, a digital signature, a counter value, or some other unique card datum. As another nonlimiting example, the authentication credential can include a biometric provided by the user including without limitation a fingerprint, facial scan, or voice scan. The user can provide the biometric to the user device which can in turn transmit it to the ATM. Alternatively, the user can provide the biometric to the ATM directly through an interactive element associated with the ATM such as a fingerprint scanner, a face scanner, or a voice scanner. As another nonlimiting example, the authentication credential can be associated with an account number, routing number, customer identification number, password, PIN number, or some other datum associated with a specific financial or banking account. It is understood that multiple authentication credentials can be requested and subsequently provided. The authentication credential can be exchanged using a diversified key exchanged discussed with further reference to FIG. 5.

In action 820, the authentication credential can be transmitted by the ATM to the server over a wired to wireless network. This action can be performed by a processor associated with the ATM.

Upon receiving the credential, the server can validate the credential in action 825. The validation can be performed by a processor associated with the server. For example, the processor can match the credential with a credential on file associated with the user. The credential on file can be hashed or otherwise encrypted to protect the user.

Having validated the credential, the server transmits a validation message to the ATM over a wired or wireless network in action 830. Next, in action 835 the ATM can transmit a user datum request to the user device over a wired or wireless network. Alternatively, the ATM can display a prompt to the user to provide their user datum. The user datum can be same user datum used previously to create the cryptocurrency wallet. The provisioning of the cryptocurrency wallet is discussed with further reference to FIG. 6.

In action 840, the user device can transmit the user datum to the ATM over a wired or wireless network, or alternatively the user can provide the user datum through an interactive element on the ATM. In action 845, the ATM can transmit the user datum to the server via a processor over a wired or wireless network.

Having received the user datum, the server in action 850 can generate via a processor or some predetermined algorithm the private key and public key. The generation of the private and public keys are discussed with further reference to FIG. 4A. Having generated the keys, the processor in action 855 can encrypt the private and public keys over the KEK. This action is discussed with further reference to FIG. 4B. In action 860, the processor can transmit the encrypted private key, encrypted public key, and KEK to the ATM over a wired to wireless network. Next, in action 865 the ATM can transmit the encrypted keys and the KEK to the user device. The keys can be transmitted over a communication field such as Bluetooth, NFC, or RFID fields.

This process can be completed any number of times upon the loss of the user's cryptocurrency wallet.

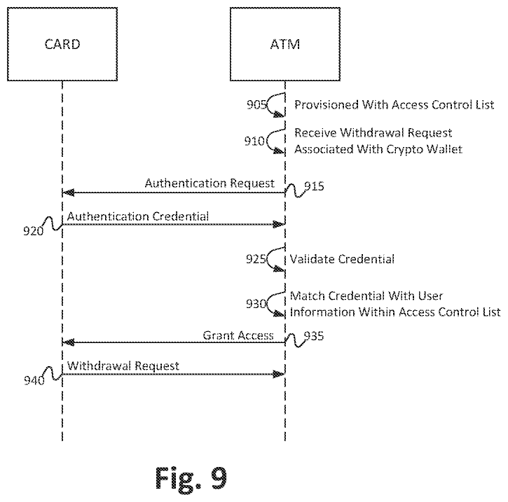

FIG. 9 is a sequence diagram illustrating a process according to an exemplary embodiment.

Once provisioned with the keys, the card can request withdrawals from the ATM via local authentication. This allows for easy and efficient access to withdrawals without the need to connect with an online server. In action 905, the ATM is provisioned with an access control list or some other authorized party list. The access control list contains the list of users or cards that are authorized to withdraw from the ATM. The list can be hashed or otherwise encrypted to protect the information of the user.

In action 910, the ATM can receive a withdrawal request associated with one or more accounts. The accounts can be associated with a cryptocurrency wallet. The request can be received from a user device over a wired or wireless network. As another nonlimiting example, the request can be received from a user directly interacting with a display or interactive element on the ATM.

In response to the withdrawal request, the ATM can send an authentication request to the card in action 915. As a nonlimiting example, the ATM can perform this step by displaying a prompt on its display element. Additionally, the ATM can open a communication field between itself and the card such as a Bluetooth, NFC, and RFID field.

In action 920, the card can transmit an authentication credential over the communication field. The authentication credential can include a unique customer identifier, a digital signature, a counter value, or some other unique card datum. The authentication credential can be exchanged using a diversified key exchanged discussed with further reference to FIG. 5.

In action 925, a processor associated with the ATM can validate the credential. This action can be performed by a processor associated with the server. For example, in action 930 the processor can match the credential with user information within the access control list. The list can be hashed or otherwise encrypted to protect the information of the user. Having matched the credentials, the ATM can send a withdrawal prompt. In action 940, the card can transmit a withdrawal amount, thus concluding a local and secure withdrawal process.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

We claim:

1. A system for the provisioning of a cryptocurrency wallet, the system comprising:
a card;
an administrator processor, wherein the administrator processor is configured to:
receive a request to generate a private key, a public key, and a key-encrypted-key (KEK),
receive a user datum from the card,
transmit the user datum to a server,
receive, from the server, at least an encrypted private key, an encrypted public key, and an encrypted KEK from the server, and
transmit, to the card, the encrypted private key, encrypted public key, and KEK; and
a server comprising:
a memory containing a database, and
a server processor, the server processor further configured to:
receive, over a network, the user datum from the administrator processor,
generate the private key and public key over the user datum,
generate the KEK,
store the private key, public key, and KEK in the database,
encrypt the private key and public key over the KEK, and
transmit, over the network, the encrypted private key, encrypted public key, and KEK to the administrator processor.

2. The system of claim 1, wherein the user datum comprises at least one selected from the group of a unique customer identifier and a counter value.

3. The system of claim 1, wherein the user datum comprises at least one selected from the group of a primary account number (PAN) and a card verification value (CVV).

4. The system of claim 1, wherein the private key and the public key are associated with a cryptocurrency wallet.

5. The system of claim 1, wherein the system further comprises a user device further comprising:
a memory; and
a user device processor, the user device processor configured to:
transmit, to the administrator processor, a second user datum, and
receive, from the administrator processor, a second private key, a second public key, and a second KEK.

6. The system of claim 5, wherein the user device is further configured to:
transmitting, to the administrator processor, a request to retrieve the first private key, first public key, and first KEK;
receiving, from the administrator processor, an authentication request;
transmitting, to the administrator processor, an authentication credential; and
receiving, from the administrator processor, the first private key, first public key, and first KEK, wherein the administrator processor has transmitted the authentication credential to the server and, in response, received the first private key, first public key, and first KEK.

7. The system of claim 5, wherein the user device comprises at least one selected from the group of a smart phone, computer, tablet, and smart watch.

8. The system of claim 1, wherein the administrator processor is further configured to open, upon receiving a request to generate the private key, public key, and KEK, a communication field.

9. The system of claim 8, wherein the communication field comprises at least one selected from the group of a near communication field (NFC), Bluetooth, and a radio frequency identification (RFID) field.

10. A method for provisioning an encrypted cryptocurrency wallet, the method comprising the steps of:
receiving, by an administrator processor, a request to generate a private key, a public key, and a key-encrypted-key (KEK),
receiving, by the administrator processor over a network, a user datum from a card,
transmitting, by the administrator processor over the network, the user datum to a server,
receiving, by the administrator processor from the server, an encrypted private key, an encrypted public key, and a KEK from the server, wherein the server has generated the private key and public key over the user datum and has encrypted the private and public keys over the KEK; and
transmitting, by the administrator processor to the card, the encrypted private key, the encrypted public, and the KEK.

11. The method of claim 10, wherein the steps further comprise:
transmitting, by a user device application to the administrator processor, a request to retrieve the first private key, first public key, and first KEK;
receiving, by a user device from the administrator processor, an authentication request;
transmitting, by a user device to the administrator processor, an authentication credential; and
receiving, by the user device from the administrator processor, the first private key, first public key, and first KEK, wherein the administrator processor has transmitted the authentication credential to the server and, in response, received the first encrypted private key, first encrypted public key, and first KEK.

12. The method of claim 11, wherein the authentication credential comprises at least one selected from the group of a unique customer identifier, a digital signature, and a message authentication code (MAC).

13. The method of claim 11, wherein the authentication credential is a biometric comprising at least one selected from the group of a fingerprint scan, face scan, and voice scan.

14. The method of claim 10, wherein the user datum comprises at least one selected from the group of a unique customer identifier and a counter value.

15. The method of claim 10, wherein the user datum comprises at least one selected from the group of a primary account number (PAN) and a card verification value (CVV).

16. The method of claim 10, wherein the steps further comprise deriving, upon receiving a lost key notification from the user, the private key and public key from the user datum.

17. The method of claim 10, wherein a user device transmits the user datum to the administrator processor over a card reader.

18. The method of claim 10, wherein the administrator processor is an automated teller machine (ATM).

19. A non-transitory computer-readable storage medium, the computer-readable storage medium including instructions that, when executed by a computer hardware arrangement comprising a processor, configure the processor to perform procedures comprising:
receiving a request to generate a private key, a public key, and a key-encrypted-key (KEK),
receiving, over a network, a user datum from a card,
transmitting, over the network, the user datum to a server,
receiving, from the server, an encrypted private key, an encrypted public key, and an encrypted KEK from the server, wherein the server has generated the private key and public key over the user datum and has encrypted the private and public keys over the KEK; and
transmitting, to the card, the encrypted private key, the encrypted public, and the KEK.

20. The computer-readable storage medium of claim 19, wherein the procedures further comprise:
transmitting, by a user device application to the administrator processor, a request to retrieve the first private key, first public key, and first KEK;
receiving, by a user device from the administrator processor, an authentication request;
transmitting, by a user device to the administrator processor, an authentication credential; and
receiving, by the user device from the administrator processor, the first private key, first public key, and first KEK, wherein the administrator processor has transmitted the authentication credential to the server and, in response, received the first encrypted private key, first encrypted public key, and first KEK.
